(19) United States
(12) Patent Application Publication
(10) Pub. No.: US 2025/0203485 A1
(43) Pub. Date: Jun. 19, 2025

(54) OPTIMIZING COMMUNICATION ROUTES BETWEEN WIRELESS COMMUNICATION NODES IN A MESH NETWORK

(71) Applicant: PowerFlex Systems, LLC, San Diego, CA (US)

(72) Inventor: Ted LEE, San Marino, CA (US)

(21) Appl. No.: 18/982,825

(22) Filed: Dec. 16, 2024

Related U.S. Application Data
(60) Provisional application No. 63/611,930, filed on Dec. 19, 2023.

(51) Int. Cl. H04W 40/04; H04W 24/08; H04W 48/20

(52) U.S. Cl. CPC H04W 40/04; H04W 24/08; H04W 48/20

(57) ABSTRACT

Aspects of the present disclosure provide techniques for optimizing communication routes for wireless mesh networks. Some examples include monitoring network information between wireless communication nodes of a wireless mesh network; generating at least one wireless communication node routing table for a selected wireless communication node based on the monitored network information; and transmitting the generated at least one wireless communication node routing table to the selected wireless communication node. Generating the at least one wireless communication node routing table includes determining link metrics between the selected wireless communication node and each of a plurality of wireless communication destination nodes based on the monitored network information; executing an optimization algorithm to generate a communication route from the selected wireless communication node to one or more wireless communication destination nodes based on the determined link metrics; and populating the at least one wireless communication node routing table with the generated communication route.

### CROSS-REFERENCE TO RELATED APPLICATIONS

This Application claims the benefit of and priority to U.S. Provisional Patent Application No. 63/611,930, filed on Dec. 19, 2023, the entire contents of which are hereby incorporated by reference.

### INTRODUCTION

In mesh networks, messages are transmitted from node to node to reach their final destination. The routing of these messages from node to node can be determined in a number of ways, but nodes typically broadcast messages which are picked up and retransmitted by neighboring nodes, repeating exponentially until the final destination is reached or until a maximum defined number of hops is exceeded. This approach can lead to network congestion, high retransmission rates, and failed message delivery due to buffer overflows, especially in large or complex network topographies like topologies involving multi-level parking structures.

To optimize message routing in mesh networks, techniques like “source routing” may be employed, where a predetermined communication route is defined so that only certain “source routed” nodes retransmit messages along a specified path. Choosing an appropriate source route currently requires manual configuration based on network conditions and layout at a given site. As network conditions are prone to change dynamically, a previously configured source route can become outdated or inefficient.

### SUMMARY

Certain aspects are related to a method for optimizing communication routes in a wireless mesh network comprising a plurality of wireless communication nodes associated with electric vehicle supply equipment (EVSE). In some examples, the method may include monitoring network information between the plurality of wireless communication nodes of the wireless mesh network; generating at least one wireless communication node routing table for a selected wireless communication node based on the monitored network information; and transmitting the generated at least one wireless communication node routing table to the selected wireless communication node. In some aspects, generating the at least one wireless communication node routing table for the selected wireless communication node comprises: determining link metrics between the selected wireless communication node and each of a plurality of wireless communication destination nodes based on the monitored network information; executing an optimization algorithm to generate a communication route from the selected wireless communication node to one or more wireless communication destination nodes based on the determined link metrics and communication route generation criteria defining objectives for communication route generation, the communication route generation criteria comprising one or more of: latency, redundancy, load balancing, energy efficiency, or security; and populating the at least one wireless communication node routing table with the generated communication route.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those described herein; and a processing system comprising means for performing the aforementioned methods as well as those described herein.

The following description and the related drawings set forth in detail certain illustrative features of one or more aspects.

### DESCRIPTION OF THE DRAWINGS

The aspects set forth in the drawings are illustrative and exemplary in nature and not intended to limit the disclosure. The following detailed description of the illustrative aspects can be understood when read in conjunction with the following drawings, where like structure is indicated with like reference numerals and in which:

FIG. 1 depicts an example computing environment for optimizing communication routes between wireless communication nodes in a mesh network, according to aspects provided herein;

FIG. 2 depicts a software configuration for an example edge environment, according to aspects provided herein;

FIGS. 3A-3C depict example device configurations for the edge environment, according to aspects provided herein;

FIGS. 4A-4C depict example hardware components that may be utilized for the devices from FIGS. 3A-3C, according to aspects provided herein;

FIGS. 5A-5B depict example hardware and data flows that may be utilized for the route optimizer of FIG. 2, according to aspects provided herein;

FIG. 6 depicts an example cloud environment, according to aspects provided herein;

FIG. 7 depicts example routing configurations between wireless communication nodes, according to aspects provided herein;

FIG. 8 depicts an example routing table managed by a route optimizer, according to aspects provided herein;

FIG. 9 depicts example data structures, according to aspects provided herein;

FIG. 10 depicts an example sequence diagram for creating and/or managing a routing table of a wireless communication node, according to aspects provided herein;

FIG. 11 depicts an example flow diagram for creating and/or managing a routing table of a wireless communication node, according to aspects provided herein; and

FIG. 12 depicts an example processing system configured to optimize communication routes between wireless communication nodes in a mesh network, according to aspects provided herein.

### DETAILED DESCRIPTION

Aspects disclosed herein include systems and methods for optimizing communication routes (which may be types of routes) between wireless communication nodes (which may be types of nodes) in a mesh network. Some aspects include a route optimizer that generates and manages routing tables of wireless communication nodes in a mesh network. The systems and methods incorporating the same will be described in more detail, below.

Wireless mesh networks may include a plurality of wireless communication nodes that relay data dynamically between one another to communicate information from a source to a destination without relying on a fixed physical layer topology. Instead, communication pathways are formed based on wireless communication node proximity and link quality metrics to facilitate flexible data communications. This adaptive nature provides reliability and scalability in mesh networks, ideal for changing environments like those in and around electric vehicle service equipment (EVSE). Requirements and operational context of EVSE can influence how communication pathways are configured and managed. For example, the need for prioritizing certain types of data, ensuring reliability and security, and adapting to dynamic network conditions can shape the routing logic in such mesh networks.

For a mesh network providing communication pathways for EVSE, certain data and data types (like real-time charging status, authentication data, and payment information) may be prioritized over other data and datatypes. Routing tables at each wireless communication node may be configured to indicate communication pathways that prioritize these types of traffic to ensure low latency and high reliability. As charging environments may expand or change configurations (e.g., adding more charging points), a route optimizer of a mesh network can dynamically configure one or more communication pathways between wireless communication nodes to adapt to these changes. Thus, a routing table in each wireless communication node might be more frequently updated to indicate the most efficient communication pathways in an evolving network topology.

Considering the nature of some functions (like payment processing and safety controls), routing tables can be configured to provide redundant communication pathways for important data flows, enhancing reliability in cases of node failure or network congestion. To avoid network congestion, especially during peak usage times in electric vehicle (EV) environments, wireless communication node routing tables may be configured to distribute data traffic more evenly across the mesh network, which helps to maintain optimal network performance. For secure data transmissions, routing tables can be configured to route sensitive data (like payment and authentication information) through more secure, possibly encrypted, communication pathways within the mesh network. In outdoor or variable environments, the mesh network can adapt to changing conditions (like interference or physical obstacles), leading to dynamic adjustments in the wireless communication node routing tables to maintain efficient data transmission. Accordingly, a network optimizer can interact with wireless communication nodes of a mesh network to refine routing tables specific to the needs posed by EV site operations.

Techniques discussed herein for dynamically optimizing communication routes in mesh networks may provide a technical solution to the technical problem of suboptimal performance of predefined or static routing logic in mesh networks. The integration of customizable route optimizations may facilitate data transmission for connectivity needs associated with EVSE operations. This may improve upon conventional routing protocols that use hardcoded rules that are insensitive to the demands of applications running at an edge environment. Further, the ability to respond to real-time network conditions may advance routing in mesh networks. The ability to interface route optimizers with existing mesh protocols may allow organizations to maintain efficient data flows aligned with EV charging requirements including security, uptime, congestion avoidance, and adaptability. Further, continually monitoring metrics and traffic patterns may facilitate technical improvements in optimizing communications as a charging infrastructure evolves.

### Example Computing Environment for Providing an Edge Hardware Platform

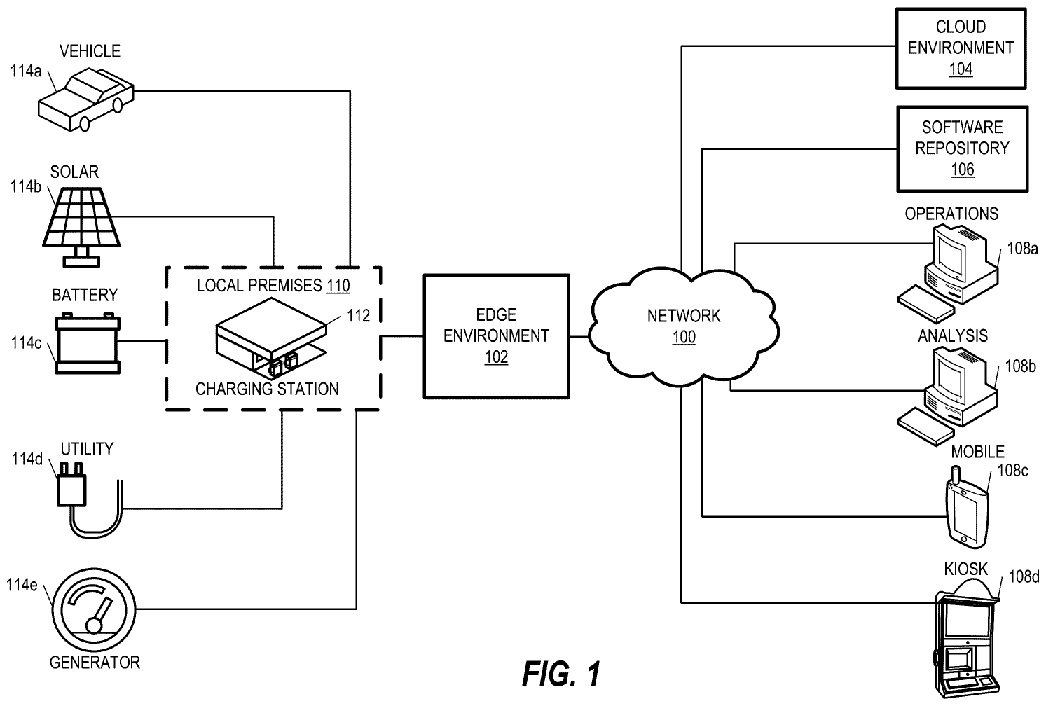

Referring now to the drawings, FIG. 1 depicts a computing environment for an edge hardware platform having the ability to generate optimized mesh network link routing between various EVSEs (which may be, for example, charging stations) located at site (illustrated as “local premises”) 110, according to aspects provided herein. As illustrated, the computing environment includes a network 100 that is coupled to an edge environment 102, a cloud environment 104, a software repository 106, as well as ancillary devices 108. The network 100 may be configured as any wide area network (WAN, such as the internet, power network, cellular network, etc.) or other network for facilitating communication among the edge environment 102, the cloud environment 104, the software repository 106, and the ancillary devices 108.

Edge environment 102 may generally be deployed at site 110 to provide various services, including coordination and optimization of energy assets 114, such as charging of electric vehicles (e.g., EV 114a) using charging station 112 and various distributed energy sources (DERs), such as solar device 114b, battery energy storage system (BESS) 114c, a grid connection to utility 114d, and generator 114e (e.g., an onsite diesel, natural gas, or other type of fueled generator). Generally, the aforementioned DERs may provide energy to the charging station 112 and/or use energy from the charging station 112 (e.g., by way of a backflow of energy from EV 114a to other aspects of site 110). In some aspects, charging station 112 may send excess energy back to the BESS 114c and/or to utility 114d. Generally, edge environment 102 may monitor and/or modify the energy sent to and received from the DERs to optimize various tasks, such as charging of energy assets 114.

Charging station 112 may utilize various communication protocols, such as open smart charging protocol (OSCP), open charge point interface (OCPI), ISO 15118, OpenADR, etc. and may represent Level 1, Level 2, Level 3, and higher-level charging stations, as applicable. Generally, the “level” of a charging station refers to the power level and/or ability to provide electric power to a device being charged.

Edge environment 102 is configured as an interface between various aspects of site 110 and network 100. In various aspects, compute resources for performing different functions at a site, such as optimization of EV charging, may be split between local compute resources in edge environment 102 and remote compute resources, e.g., in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some aspects may be configured such that the cloud environment 104 may serve a plurality of edge environments 102 that each serve one or more sites 110, one or more charging stations 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some aspects, software repository 106 may be configured as a proprietary service and/or may be provided by a third-party, such as GitHub™. Additionally, some aspects may be configured such that the software repository 106 is provided by the same entity that manages the cloud environment 104. As such, these aspects may be configured such that software repository 106 and cloud environment 104 may be combined.

Also depicted in FIG. 1 are the ancillary devices 108. Ancillary devices 108 may include an operations device 108a, an analysis device 108b, a mobile device 108c, a kiosk 108d, and/or other devices. Specifically, operations device 108a may be utilized to monitor and/or alter operations of the environment provided in FIG. 1. The analysis device 108b may analyze utilization, operation, charging, and/or other features of the computing environment. The mobile device 108c may represent an administrator device and/or a user device. As a user device, the mobile device 108c may initiate charging, payment, and/or perform other user-specific actions. As an administrator device, the mobile device 108c may perform administrative operations, analysis, and/or perform other actions. The kiosk 108d may be located at one of the charging stations 112 and/or remote therefrom and may provide user-specific or administrative actions, similar to that of the mobile device 108c. In some aspects, administrators may use the kiosk 108d to view information about the site or make changes. As will be understood, the ancillary devices 108 may each include a processor, a memory component, and/or other hardware and/or software for performing the functionality provided herein. It should be understood that while kiosk 108d is depicted as being remote from site 110, some aspects may not be configured in this manner. Specifically, some aspects may utilize a local kiosk 108d, which may communicate via a local network and/or the network 100 for providing the services described herein.

### Example Aspects of an Edge Environment

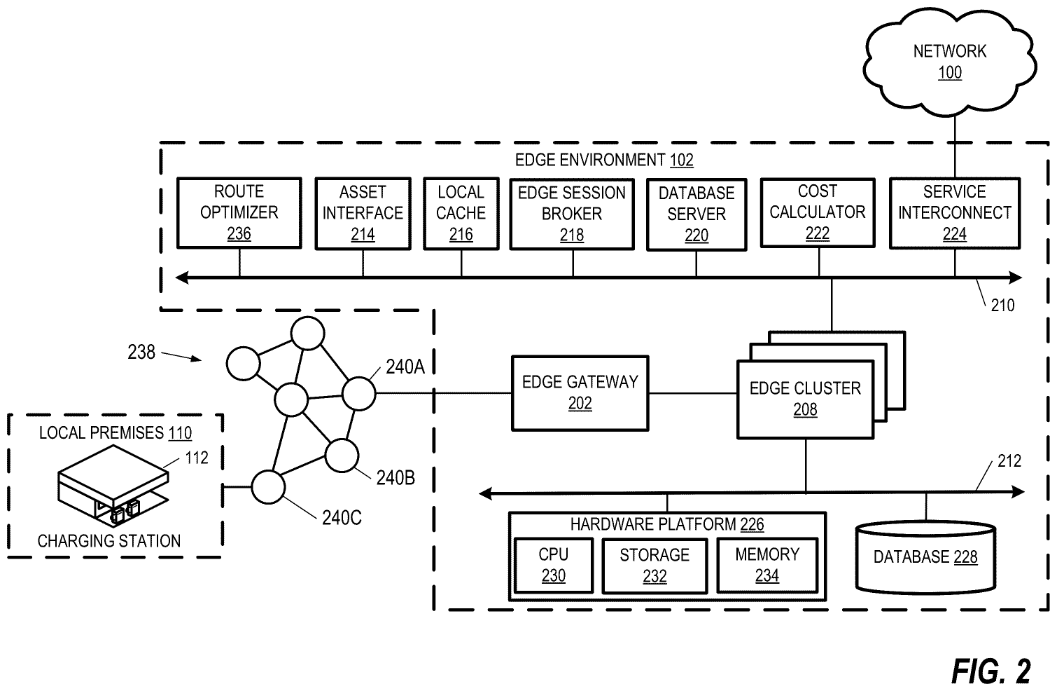

Referring to FIG. 2, the edge environment 102 may be coupled to the site 110 via an edge gateway 202. Edge environment 102 may be operatively coupled to aspects of site 110, such as charging station 112 via edge gateway 202. Edge environment 102 further includes an edge cluster 208, which is coupled to communication bus 210 and hardware bus 212. Communication bus 210 is coupled to local cache 216, edge session broker 218, database server 220, cost calculator 222, and service interconnect 224 in this example. Also coupled to communication bus 210 are asset interface 214 and route optimizer 236. Hardware bus 212 is further coupled to hardware platform 226, which may include one or more processors, such as CPU 230, storage component 232, memory component 234, route optimizer 236, and/or other hardware components. Also coupled to hardware bus 212 is database 228.

Buses 210, 212 may be utilized to facilitate operation of all services that run in edge environment 102 and communicate with each other via a distributed message streaming system. The coupling of these aforementioned services may be accomplished in some aspects via a distributed message streaming system, such as a message-oriented middleware like NATS.

In the depicted example, charging station 112 is configured for communication with edge environment 102 via edge gateway 202 using a short-range wireless network technology, such as a mesh network 238. The mesh network 238 can include a plurality of wireless communication nodes 240 configured to relay communications from the edge gateway 202 to the charging station 112 and/or from the charging station 112 to the edge gateway 202. In examples, a communication from the edge gateway 202 is received at node 240A of the mesh network 238, the node 240A can relay the communication to node 240B, the node 240B can relay the communication to node 240C, and the node 240C can relay the communication to the charging station 112. In other examples, a communication from the charging station 112 is provided to the node 240C, then node 240B, and then to node 240A, such that the information is relayed from the charging station 112 to the edge gateway 202. A non-limiting example of the mesh network 238 is ZigBee® PAN. Although the charging station 112 is depicted as communicating with the edge gateway 202 via the mesh network 238, it should be understood that energy assets 114 and other devices residing at site 110 can be configured to utilize the mesh network 238 when communicating between one another and/or when communicating with edge environment 102. The mesh network 238 may be maintained and/or otherwise controlled by route optimizer 236. The edge gateway 202 may be configured to receive data, such as electric charging data, price charge data, vehicle data, etc. from the charging station 112 and/or vehicles that are being charged via the connection with the site 110 (of FIG. 1).

In some aspects, edge gateway 202 may be configured to abstract data received from aspects of site 110 (of FIG. 1), such as charging station 112, to remove protocol-specific distinctions. For example, a first charging station may utilize a first communication protocol and/or billing protocol and a second charging station may utilize a second communication protocol and/or billing protocol. Edge gateway 202 may receive data packets from both the first charging station using the first communication protocol and the second charging station using the second communication protocol and may transform the received data into a protocol-agnostic format prior to providing the data to edge cluster 208. This allows wide interoperability between edge environment 102 and various types of hardware (e.g., charging station 112) at a site.

Edge cluster 208 is the central message center in various aspects. For example, when a user plugs a vehicle into a charging station 112, edge cluster 208 receives data from edge gateway 202, parses that data (e.g., to generate access state data) and causes the state data to be sent to the database server 220. Edge cluster 208 also receives the data and creates a session entry, which may be stored in the local cache 216. Edge cluster 208 may additionally send the session entry to cloud environment 104 (of FIG. 1) via network 100. Edge session broker 218 may also receive data related to the new session and may query database server 220 to access additional session data to determine charging characteristics for charging station 112.

The edge session broker 218 may produce data or signals that are sent to the edge cluster 208, which may be sent to the edge gateway 202 for potentially sending back to one or more of charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and energy sources, such as the charging station 112.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

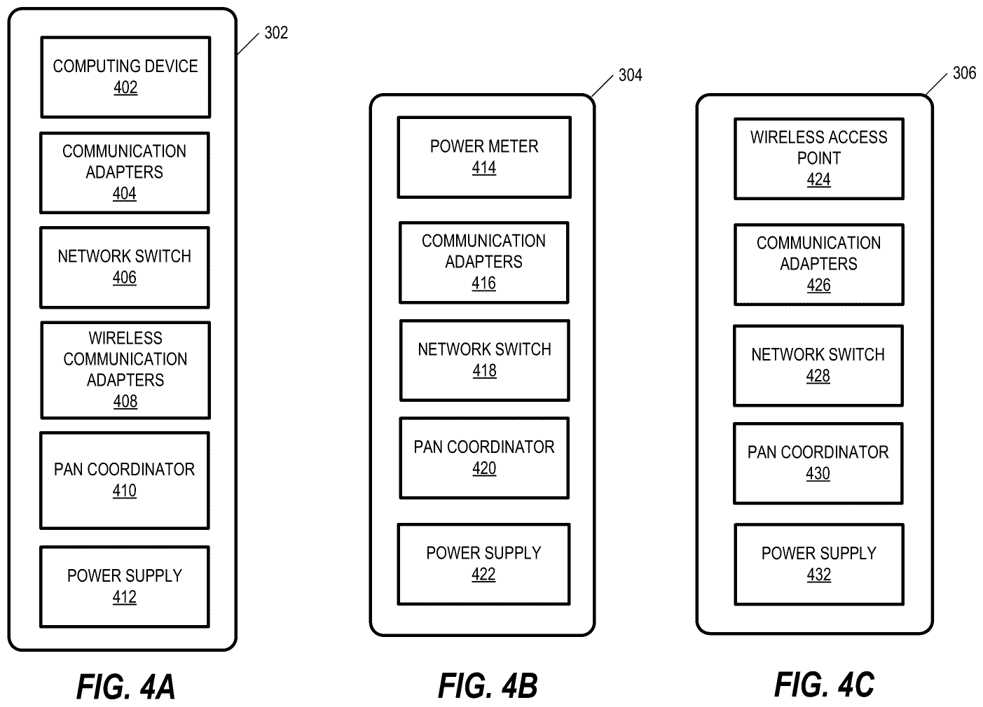

Hardware platform 226 represents any hardware for facilitating the processes and actions described herein. Specifically, CPU 230 may represent one or more types of processing device configured for executing instructions. Storage component 232 may be configured as long-term storage, such as a hard drive or the like. Memory component 234 may include any of various types of read or access memory or the like. Database 228 may be configured for additional storage and may be housed with the other hardware and/or elsewhere. Examples of different hardware platforms that may be deployed in edge environment 102 are described further below with respect to FIGS. 4A-4C.

Route optimizer 236 can generate one or more communication routes utilizing the hardware platform 226 of the edge environment 102. In examples, the route optimizer 236 dynamically optimizes communication routes that messages take across the mesh network 238, such as a ZigBee or other wireless mesh network. The route optimizer 236 can analyze data about the mesh network topology, link quality between nodes, traffic patterns, and other metrics. This allows the route optimizer 236 to model the network and apply one or more optimization algorithms to determine efficient pathways for routing data packets between any two nodes in the network, where a node in the network may include EVSE at site 110, such as charging station 112, and/or wireless communication nodes specifically arranged to enable mesh network communications.

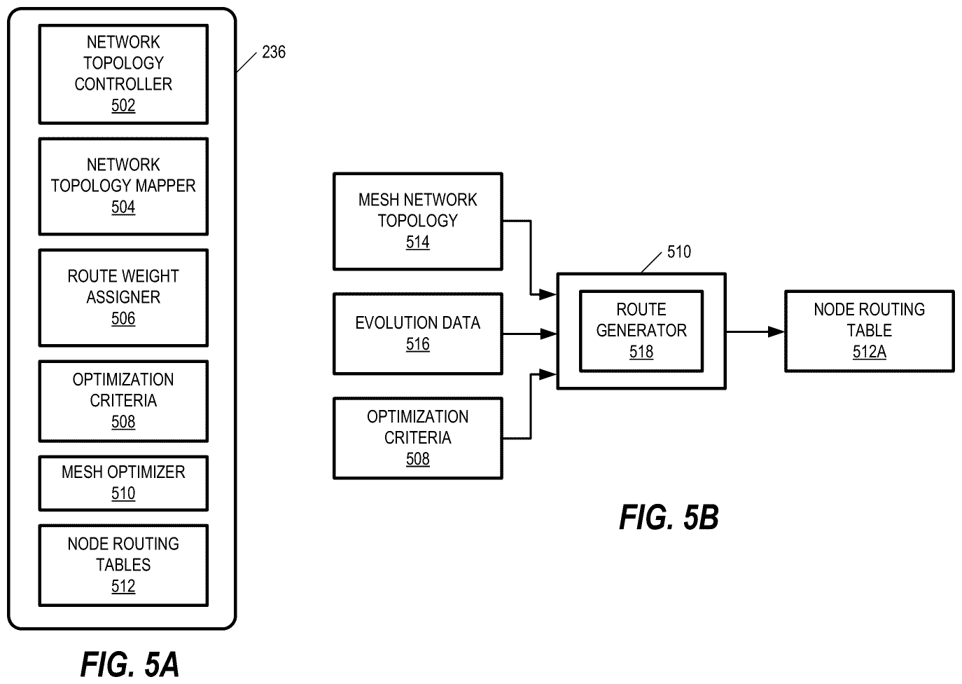

In examples, the route optimizer 236 maps out the network topology by discovering active nodes and the connections between them; assigns weights or costs to potential communication routes based on criteria like signal strength, latency, number of hops, etc.; employs algorithms like linear/quadratic programming to find communication routes that optimize the network for lowest cost; generates routing tables with the optimized paths for each node; and dynamically adjusts the routing decisions over time as conditions on the network change. In some examples, the route optimizer 236 runs autonomously to configure and reconfigure node communication routes to maintain optimal data flow and reliability across the mesh network 238. The route optimizer 236 can automatically resolve network issues when encountering problems like congestion, failing nodes, interference, etc. This eliminates the need for manual routing configuration. An example implementation of a route optimizer 236 that may be deployed in edge environment 102 is described further below with respect to FIGS. 5A-5B.

### Hardware Configurations for Edge Environment

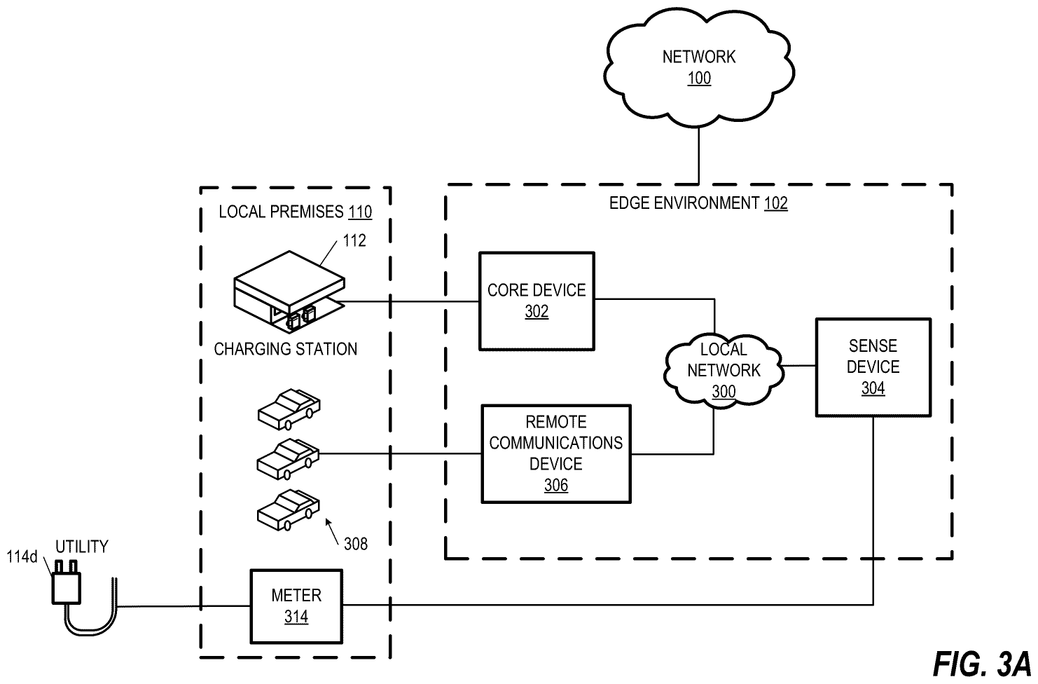

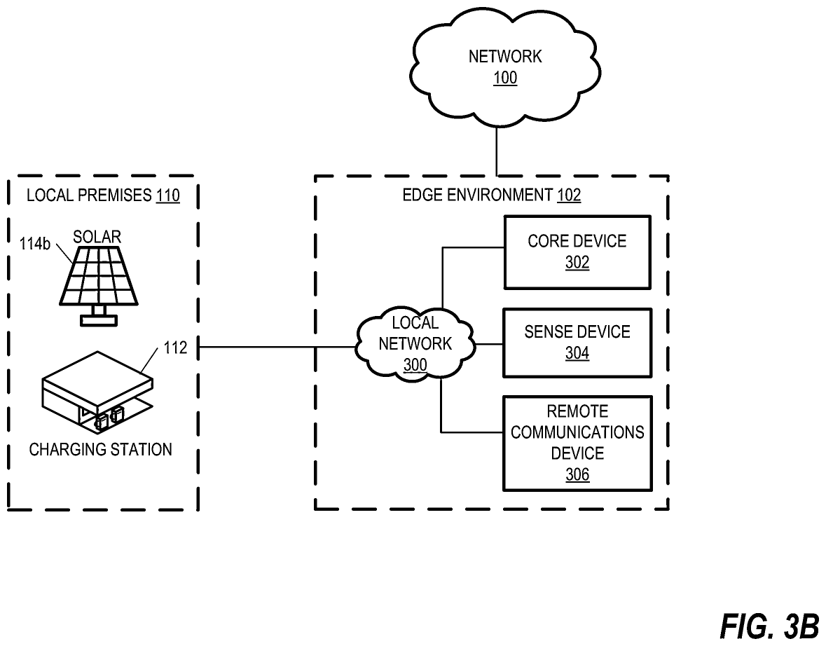

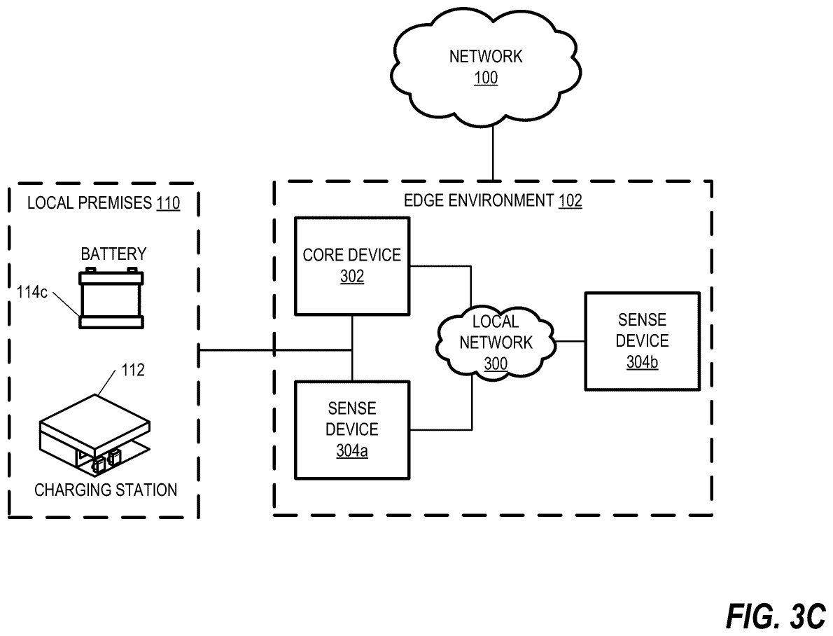

FIGS. 3A-3C depict example hardware configurations for the edge environment 102, according to aspects provided herein. Specifically, FIG. 3A depicts a charging solution. As illustrated, the charging station 112 is coupled to a local network 300 via core device 302. The local network 300 may include any local area network, Ethernet, PAN, etc. The core device 302 may be physically installed within communications range of the chargers in the charging station 112. A sense device 304 may be installed, for example, in an electrical room or in another enclosure with electrical equipment of the charging station 112 and/or one or more energy assets 114 to monitor the main metering point for the local utility point of common coupling. This enables algorithms to provide the optimal dispatch of EV charging power, subject to local energy rates and the vehicles currently charging. In the case that there are vehicles 308 using EV chargers that are out of communications range of the core device 302, such as at a sub-level of a parking garage, at least one remote communications device 306 is included as required. Also included at the site 110 is a meter 314 for communicating energy with the utility via a connection to utility 114d.

In aspects of FIG. 3A, the core device 302 is the central processing device and serves as the communications hub. The core device 302 may provide optimization, load management, communication coordination, and data historian services. The core device 302 communicates with the cloud environment 104 via cellular modem, wired internet service provider (ISP), and/or other communications medium to get current optimization and load management set points for charging stations 112 and other assets, such as via an optimization algorithm that may be stored locally and/or at the cloud environment 104. It will be understood however, that some aspects may be configured such that the core device 302 performs optimization locally. Regardless, the core device 302 dispatches these set points, through a local communications protocol (e.g., Wi-Fi) and/or via a mesh network or the remote communications device 306 to reach locations that are distant or hard to reach, such as charging stations with a core device 302 and/or sense device 304 at sub-levels of a parking garage or a rooftop solar inverter. The core device 302 additionally collects data directly from distributed energy resources and power measurement devices or through cloud-based communications with the network 100.

Power and energy metering data may be collected via the sense device 304. The sense device 304 may include a smart meter with support for multiple single-and three-phase loads with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar or for monitoring of a new inverter associated with a rooftop solar installation.

FIG. 3B depicts a solar application where the core device 302 and the sense device 304 are installed in the facility's electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 are installed physically near a BESS 114c storage installation. In cases where the BESS 114c is near the point of common coupling with the utility 114d, a single sense device 304a can monitor the full site. In cases where there is a significant distance to the metering point for the utility 114d, a second sense device 304b (or a plurality of sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C, according to aspects provided herein. Specifically, FIG. 4A depicts hardware components that may be present in a core device 302. In some aspects, the core device 302 is the brain where the energy optimization and adaptive load management functions are executed and dispatched. As illustrated, the core device 302 may include a computing device 402, a communication adapter 404 (or more than one), a network switch 406, a wireless communication adapter 408 (or more than one), a PAN coordinator 410, and a power supply 412. As will be understood, the computing device 402 may include a processor, memory, and/or other components that a normal, specific purpose machine may utilize. In some aspects, the computing device 402 may include powerline communication (PLC) infrastructure, while some aspects may utilize retail and/or micro-industrial computer components for optimization, load management, communication coordination, and/or historian services.

The communication adapter(s) 404 may be configured for load balancing and otherwise managing communications, for example, Modbus RTU (RS485) to Modbus TCP (Ethernet) or Ethernet IP (RJ45) to Ethernet Optical (SFP), etc. The network switch 406 may be configured for routing of network traffic and may be configured as an Ethernet switch for communication to other nodes (e.g., the sense device 304, the remote communications device 306, and/or other core device 302), distributed energy resources, and/or energy-based management systems.

The wireless communication adapter(s) 408 may include a cellular modem, internet modem, Wi-Fi access point, etc. for facilitating wireless communications to the internet or other wide area network. Similarly, the PAN coordinator 410 may be configured to create and/or join communication connections with other devices. This may include a mesh network coordinator, such as a Zigbee coordinator, Bluetooth device, and/or other device for performing this function. The power supply 412 may be configured as a battery power, connection to external power, etc.

It should be understood that in some aspects, the computing device 402 may be embodied as part of the edge environment 102 depicted in FIG. 2. Specifically, the core device 302 may be configured as the central computing device of the edge environment 102 and thus may provide the processing and workflow described with reference to FIG. 2. Some aspects are not so limited.

FIG. 4B depicts hardware components of the sense device 304 from FIGS. 3A-3C. The sense device 304 may be configured as a smart-metering piece for collection and storage of power/energy data including but not limited to measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. These aspects may be optimized for ease of installation and reduced intrusion to the site. Power over Ethernet (PoE) sourced from the core device 302 suffices for most installations. The sense device 304 may transmit data back to the core device 302 via a network switch. The sense device 304 is optimized to utilize minimal power and PoE is acceptable for most installations.

As illustrated in FIG. 4B, the sense device 304 includes a power meter 414, a communication adapter 416 (or more than one), a network switch 418, a PAN coordinator 420, and a power supply 422. The power supply 422 may include a power interface for providing power to the sense device 304. The power meter 414 may be utilized for monitoring single-phase and three-phase loads of power. The communication adapter(s) 416 may be utilized for facilitating communications between the sense device 304 and other devices. The network switch 418 may be a PoE enabled switch for communication. Similarly, the PAN coordinator 420 may create and/or join personal area networks, such as via Zigbee, Bluetooth, and the like. Accordingly, the PAN coordinator 420 may include a mesh network coordinator, such as a Zigbee coordinator, Bluetooth device, and the like. In some aspects, PoE or other power sources may be utilized.

As illustrated in FIG. 4C, the remote communications device 306 is a network-connectivity extension, primarily for EV charging or solar monitoring locations where mesh networks, Wi-Fi, or Ethernet is being extended to remote or difficult-to-reach locations such as remote subpanels, parking garage levels, or rooftop inverters. Some aspects are optimized for ease of installation and reduced intrusion to the site where PoE suffices for most installations from the core device 302. The remote communications device 306 may be configured to transmit data back to the core device 302 via the network switch.

Specifically, the remote communications device 306 may include a wireless access point 424, a communication adapter 426 (or more than one), a network switch 428, a PAN coordinator 430, and a power supply 432. The wireless access point 424 may be configured to extend wireless communication signals to chargers and/or other intelligent electronic devices. In some examples, the wireless access point 424 may be configured to extend wireless communication signals via a mesh network. The communication adapter(s) 426 may be configured for facilitating communications between the remote communications device 306 and other devices. The network switch 428 may be configured as a PoE Ethernet switch and/or another network switch for communicating with the core device 302. The PAN coordinator 430 may be configured to create and/or join personal area networks. This may include a mesh network coordinator, such as a Zigbee coordinator, Bluetooth device, and the like. The power supply 432 may include a power interface for providing power to the remote communications device 306.

### Components of Route Optimizer

FIG. 5A depicts one or more components that may be utilized for route optimizer 236 of FIG. 2 in accordance with examples of the present disclosure. The route optimizer 236 can include a plurality of interrelated components, each contributing to the overall functionality of a mesh network optimization system within an edge computing environment. In examples, the route optimizer 236 can include a network topology controller 502, a network topology mapper 504, a route weight assigner 506, optimization criteria 508, a mesh optimizer 510, and one or more node routing tables 512. The individual components and their interrelationships are described below. Though shown as separate components, the components may be implemented separately, jointly, or as any number of components that perform the discussed functions. The components may be hardware and/or software, such as processors, memory, computer-readable medium, instructions, code, etc.

The network topology controller 502 can function as the command-and-control center for the mesh network. In examples, the network topology controller 502 is configured to initiate topology discovery protocols, manage and respond to dynamic changes in the network, and enforce topology management policies. The network topology controller 502 oversees the overall structural integrity and efficiency of the network topology, ensuring that the mesh network 238 (of FIG. 2) adheres to the specified design and operational parameters. For example, if a node becomes unreachable for a duration of time, the network topology controller 502 can ensure that new communication routes between nodes affected by the unreachable node are established such that nodes of the mesh network are able to maintain communication in a mesh-like manner while still adhering to operational parameters, such as throughput, latency, etc.

The network topology mapper 504 is configured to create one or more representations of the network's topology. In examples, the network topology mapper 504 surveys and records the active and inactive wireless nodes within the mesh network 238 and the links between these nodes. This mapping can provide information that underpins one or more routing strategies by providing a comprehensive layout of the mesh network 238 for reference by other components. The route weight assigner 506 is configured to assign values to possible communication routes between nodes within the mesh network 238 based on predetermined criteria. These predetermined criteria may include, but are not limited to, signal strength, number of hops, latency, and bandwidth availability. The route weight assigner 506 facilitates the determination of the communication routes (e.g., optimized communication routes) for data packets to traverse the mesh network 238.

Optimization criteria 508 include parameters set forth to guide the mesh optimizer 510 in achieving network objectives. These optimization criteria 508 can be customized to prioritize certain network behaviors, such as minimizing energy consumption of nodes, reducing overall latency, avoiding congested network segments, evenly distributing the network load among available nodes, anticipating and avoiding future network congestion, enhancing reliability and redundancy, and maintaining secure communications.

The mesh optimizer 510 utilizes data provided by the route weight assigner 506 and guided by the optimization criteria 508 to apply algorithmic strategies to obtain communication routes (e.g., optimized communication routes, such as having reduced latency, increased security, redundancy, or the like) for data transmission within the mesh network 238. The mesh optimizer 510 may dynamically adjust the network routing decisions to optimize network performance and reliability, such as in real-time, such accounting for the ever-changing conditions within the mesh network.

Node routing tables 512 include one or more routing tables for one or more wireless communication nodes 240. That is, each wireless communication node in mesh network 238 possesses a routing table maintained in the node routing tables 512 and updated by the network topology controller 502. The node routing tables 512 include updated information on (e.g., the most efficient) paths to nodes within the mesh network 238, such as determined based on the current network topology and route weights. Respective node routing tables 512 can be provided to the wireless communication nodes 240 such that each respective node adheres to decisions on packet forwarding as established by the network topology controller 502, which may provide optimal data flow across the network.

Collectively, in some cases, the components of the route optimizer 236 can work in concert to facilitate an intelligent, self-optimizing mesh network 238 that is robust, efficient, and adaptable to the fluctuating demands and conditions of an edge computing environment. The described system may be beneficial for managing complex network topologies and may be particularly suited for applications requiring high reliability and low latency in data transmission.

### Process for Generating a Routing Table

FIG. 5B depicts a schematic representation directed to generating one or more node routing tables for a mesh network 238. As depicted in FIG. 5B, multiple inputs are provided to the mesh optimizer 510 to facilitate dynamic communication route generation within the mesh network 238. In examples, the mesh network topology 514 refers to a current layout of the mesh network and includes data on the nodes and interconnecting links that form the infrastructure of the mesh network 238. The mesh network topology 514 is provided such that route generator 518 can understand the physical and logical arrangement of the mesh network 238 and make informed routing decisions. In examples, the mesh network topology 514 may be provided from the network topology controller 502, network topology mapper 504, and/or route weight assigner 506.

Evolution data 516 represents a dynamic and temporal dataset that provides information concerning the changes in the network over time. This data may include nodes joining or leaving the network, variations in link quality, and shifts in traffic patterns, thereby allowing the route optimization module (route optimizer 236) to adapt, and in some cases anticipate, evolving network conditions.

The optimization criteria 508 previously described in FIG. 5A, provides a set of guiding principles or objectives for route generator 518 to follow. The optimization criteria 508 may help to ensure that the routing decisions align with the overarching goals for network performance, such as minimizing latency, maximizing throughput, or conserving energy.

The route generator 518 is an entity tasked with synthesizing the inputs received into (e.g., optimal) routing paths. The route generator 518 employs algorithms to process the mesh topology, evolution data, and optimization criteria to construct routing tables, which may be tailored to the current and predicted states of the network. In examples, the route generator 518 may execute a pathfinding algorithm using the route weight assigner 506 and optimization criteria 508 data to calculate a path for each node to another destination node in the mesh network 238. In some examples, route generator 518 can identify several potential paths, selecting the one that (e.g., best) meets the optimization criteria 508. In some examples, the destination node may be a network coordinator and the (e.g., optimal) path may comprise two or more communication routes, where a first communication route may be from a source to another wireless communication node and a second communication route may be from the another wireless communication node to the network coordinator.

In certain aspects, route generator 518 configures mesh network routing to (e.g., best) meet connectivity demands of EVSE operations. This may be achieved by applying algorithmic strategies that dynamically tune the underlying mesh network topology and data routing pathways in accordance with user-defined optimization objectives. In examples, the route generator 518 mathematically formalizes desired mesh network characteristics into optimizable objectives. This may be realized by mapping identified optimization criteria 508 into cost and benefit terms which numerically represent qualitative system attributes that are to be minimized or maximized.

For instance, if the goal is to balance traffic evenly across the mesh network, this goal may get translated into a cost term that increases proportionally to the difference in data flow observed between node pairs. To minimize this cost variable across all network links simultaneously, communication packets may be spread across underutilized communication routes. Similar formulations may be derived to capture latency impacts, route redundancy levels, radio interference, and other factors that substantively impact the mesh network's capability to efficiently sustain EV services.

With the optimization objectives fully characterized mathematically through cost assignments, in some examples, the route generator 518 can run these objective functions through network graph analysis algorithms that iteratively modify routing configurations until a (e.g., ideal, lowest-cost) pathway allocation is discovered. The output of the route generator 518 is a node routing table 512A, for one or more wireless communication nodes, that implements coordinated communication routing decisions to implement an optimized mesh network configuration based on the optimization criteria 508. Other types of optimization algorithms that could be utilized instead of or in addition to network graph analysis algorithms include, but are not limited to linear and nonlinear mathematical optimization techniques or algorithms that find the minimums or maximums of objective functions with linear and nonlinear constraints to find (e.g., optimal) routing solutions; metaheuristic algorithms that use iterative generation processes to find solutions, like genetic algorithms, particle swarm optimization, ant colony optimization, etc.; machine learning algorithms (e.g., machine learning-based optimization algorithms) including supervised, unsupervised, and reinforcement learning algorithms developed to take in network data and optimization criteria to train predictive models that output routing decisions; and accessibility algorithms that use probability distributions and stochastic processes to search spaces for (e.g., optimal) paths (e.g., Bayesian optimization).

As previously described, the node routing table 512A contains (e.g., optimized) routing paths that are specific to each node within a mesh network, such as mesh network 238. In certain aspects, the route optimizer 236 generates and maintains optimized routing tables for nodes within a mesh network by processing real-time and historical data about network topology and performance. The route optimizer 236 may enable the mesh network, such as mesh network 238, to dynamically adapt to changing conditions, such as to ensure optimal data flow and network reliability.

### Components of Cloud Environment

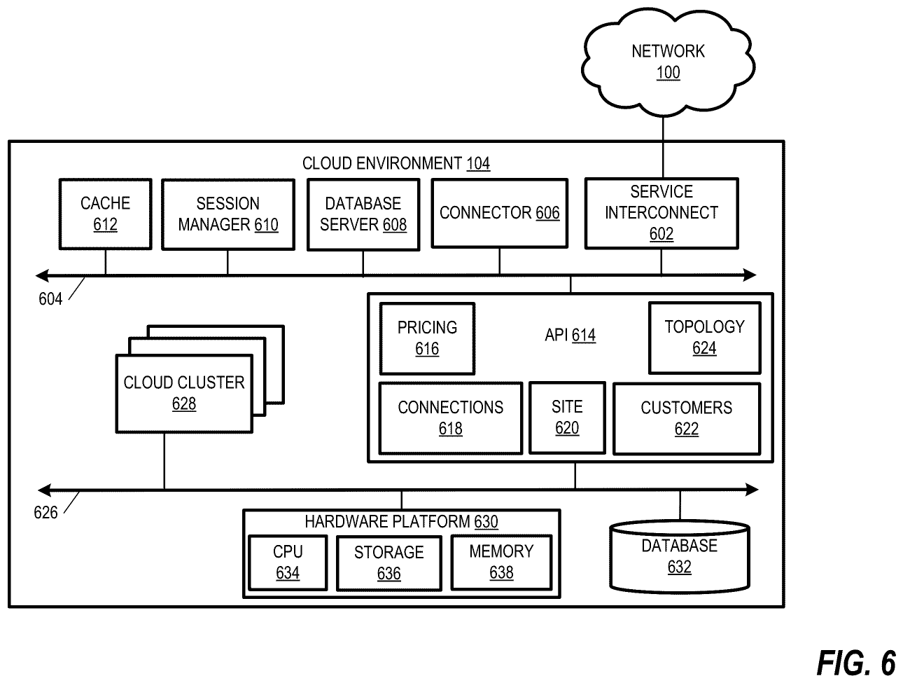

FIG. 6 depicts a cloud environment 104 according to aspects provided herein. As illustrated, the network 100 may couple to the cloud environment 104 via a service interconnect 602 that corresponds with the service interconnect 224 from FIG. 2. Similar to the service interconnect 224 from FIG. 2, the service interconnect 602 may be configured to facilitate an HTTP, TCP, and/or other communication portal through the network 100 to the edge environment 102 for the exchange of data between the edge environment 102 and the cloud environment 104. Service interconnect 602 is also coupled to a communication bus 604, which facilitates communication among various components of FIG. 6. Also connected to the communication bus 604 are a NATS connector 606, a database server 608, a session manager 610, a cache 612, and a collection of services and application programming interfaces (APIs) 614. The APIs 614 may include a pricing API 616, a connections API 618, a site API 620, a customers API 622, and a topology API 624. API 614 may be implemented by hardware platform 630. The hardware bus 626 is coupled to a NATS cloud cluster 628, as well as a hardware platform 630 and a database 632. The hardware platform 630 may include a CPU 634, a storage component 636, and a memory component 638.

The API 614 is a component of cloud environment 104. As such, the API 614 and its sub-components (e.g., pricing API 616, connections API 618, site API 620, customers API 622, and/or topology API 624) may cause storage of and/or process site information, site topology, customers, connections to panels, constraints of panels, pricing information of each site, local forecasting services, optimization services, controller services, and/or caching services, etc. The API 614 may also serve as a mobile backend by storing personal information of charge users (e.g., email, charging preferences, payment preferences, privileges, access, fleet information, etc.). The API 614 may additionally store peak charging configurations, data related to meter setup, etc.

When a vehicle is plugged into a charging station 112 (FIG. 1), the edge session broker 218 (FIG. 2) communicates connection information to the API 614. The connection information may include vehicle information, user information, charging station information, etc. The API 614 then creates a charge session object, which is stored in cache 612. Cache 612 sends session data, along with topology constraints and the charge session object, to the edge environment 102. The NATS connector 606 may additionally cause the NATS cloud cluster 628 to maintain the charge session object for retrieval by an interested party. As the session continues, session manager 610 may be utilized to alter constraints of the session, which may cause the NATS cloud cluster 628 to update the charge session object.

When a user claims a previously created session with the mobile device 108c, the database server 608 may create a database entry with the charge session, driver, along with energy request, willingness to pay, electricity purchased, etc. The NATS connector 606 may update the NATS cloud cluster 628 with the database entry. This data may then be sent to the edge environment 102. When the charge session ends (e.g., the vehicle is unplugged), that action will be added to the database entry and the database entry may be moved from a current sessions list to a completed sessions list.

As indicated above, the hardware platform 630 may represent hardware that may be utilized to execute the components described regarding FIG. 6. As such, the CPU 634 may be configured as any processing unit for receiving and executing computer-readable instructions. The storage component 636 may be configured as any hard drive or other local storage device. The memory component 638 may be configured as any type of RAM, ROM, registers, etc. or the like.

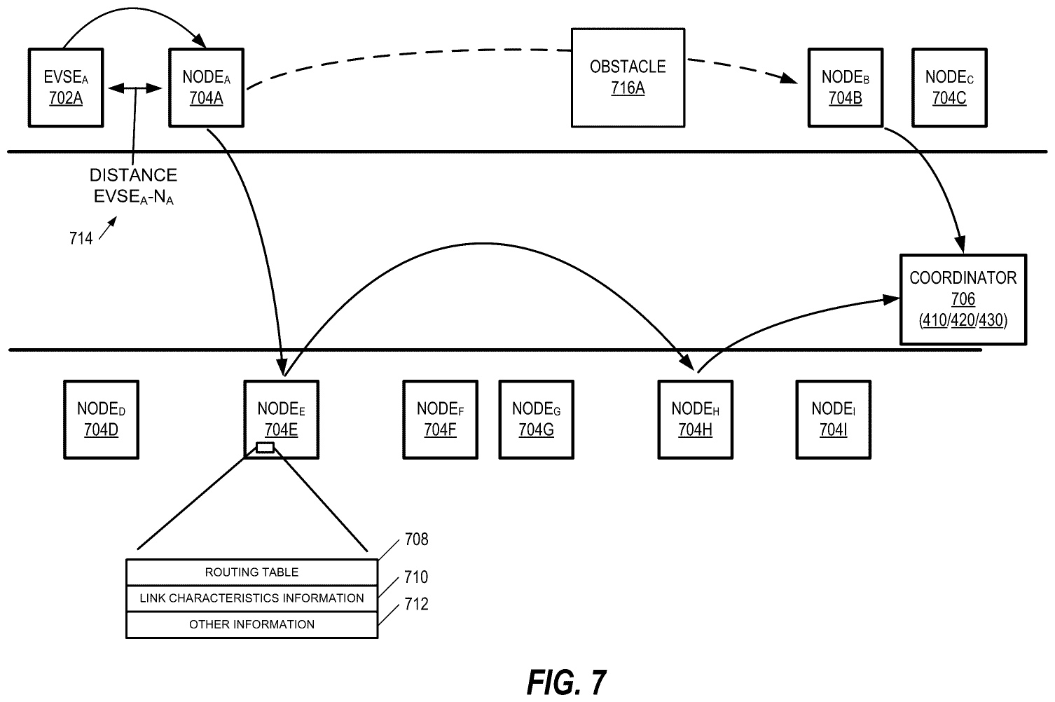

FIG. 7 depicts an example representation of a communication route and interaction diagram pertaining to a mesh network, such as mesh network 238. The diagram illustrates the routing pathways and decision-making processes of wireless communication nodes within a mesh network environment as they relate to the transportation of data packets, and the role of a mesh network coordinator 706 in the administration of the mesh network, where the mesh network coordinator 706 may be the same as or similar to one or more of the PAN coordinator 410, 420, and/or 430 (FIG. 4).

The mesh network coordinator 706 oversees the orchestration of network traffic and the management of routing protocols. In some cases, it is tasked with maintaining the network's integrity and ensuring efficient data flow between nodes. The mesh network coordinator 706 may also be responsible for the network's initialization, control of admission of new nodes, and/or the maintenance of network-wide routing policies. In certain aspects, a new node may refer to a node that was previously not part of a network such as a mesh network, not discovered or detected as being part of the network, or the like. Where the route optimizer 236 generates communication routes, the mesh network coordinator 706 may ensure the wireless communication nodes implement the communication routes generated from the route optimizer 236.

A series of wireless communication nodes 704A to 704I represent individual network components capable of sending, receiving, and forwarding data packets. Each wireless communication node 704A-704I may be equipped with the capability to implement (e.g., the most efficient, optimized, or efficient) routing paths for data transmission, based on information contained within their respective routing table 708. Alternatively, or in addition, route optimizer 236 determines routing paths for data transmission based on information contained within the respective routing table 708 and/or information collected via the network topology mapper 504 for example. The routing table 708 contains a mapped set of potential pathways for data packets to reach their destination. The routing table 708 can be dynamically updated to reflect (e.g., based on) the current state of the network topology, such as to ensure that data routing remains efficient and reliable. In some examples, updated routing tables 708 can be provided by route optimizer 236. In examples, the mesh optimizer 510 can generate a node routing table 512A which can be provided to a respective wireless communication node 704A-704I for use as the routing table 708.

Each wireless communication node 704A-704I may also include link characteristics information 710 comprising a dataset that informs the route optimizer 236 with details on the quality and characteristics of the links between wireless communication nodes. In certain aspects, the details on the quality and characteristics may be for neighboring nodes. Factors such as bandwidth, latency, error rates, and/or signal strength may be obtained by the wireless communication node 704A-704I, stored at the node, and forwarded to the route optimizer 236 for consideration. In some aspects, a distance vector 714 between EVSE unit 702A and wireless communication node 704A represents a quantifiable metric that can be used by the route optimizer 236 to determine the (e.g., optimal) path for data packets based on distance, which may be a composite metric that includes not just physical distance but also network latency or hop count. Such information may be included as linked characteristics information 710.

In some examples, each wireless communication node 704A-704I may include other information 712 which may affect routing decisions generated by the route optimizer 236. In examples, other information 712 may include, but is not limited to energy constraints, security protocols, hardware capabilities, or prioritization directives, which are factored into the routing algorithms to ensure compliance with broader network objectives.

FIG. 7 also illustrates an EVSE unit 702A connected to wireless communication node 704A, which demonstrates the network's ability to interface with practical applications such as an electric vehicle charging infrastructure. In some examples, a communication route between EVSE unit 702A (EVSEA) and the mesh network coordinator 706 may include utilizing node 704B. In some instances, the mesh network coordinator 706 may correspond to one or more of the PAN coordinators 410, 420, and/or 430. Accordingly, charging information and EVSE information can be provided to the edge environment 102 and/or the cloud environment 104 via a mesh network implementation. In some examples, a wireless communication link between wireless communication nodes may become obstructed by an obstacle, such as obstacle 716A and as indicated by the dashed line between wireless communication nodes 704A and 704B. Rather than ceasing communications, route optimizer 236 may detect that link characteristics information 710 received from node 704B for example, indicates that wireless communication node 704A is inaccessible via an existing communication route. However, route optimizer 236 may also receive link characteristics information 710 from wireless communication node 704E indicating that the communication pathway between wireless communication nodes 704A and 704E supports wireless communication. Accordingly, route optimizer 236 can generate a new communication route to be provided to wireless communication node 704A such that wireless communication node 704A communicates with wireless communication node 704E as a preferred communication route. Accordingly, the network depicted in FIG. 7 can adapt and adjust routing paths in the presence of physical barriers.

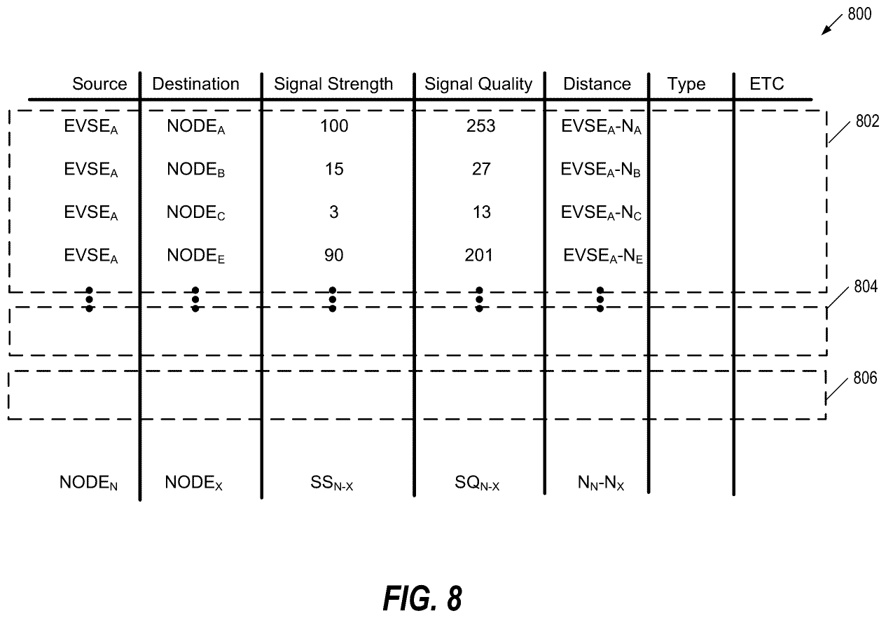

FIG. 8 depicts an example routing table 800 utilized within a mesh network, such as mesh network 238, for managing communication pathways between wireless communication nodes. The routing table 800 enables the determination of optimal pathways for data transmission and contains a comprehensive array of routing information, with multiple entries corresponding to communication routes between nodes. Each entry in the routing table 800 is detailed with metrics indicative of a link's characteristics. The routing table 800 may correspond to the node routing tables 512 (of FIG. 5) and reside at the route optimizer 236. The route optimizer 236 may utilize information from the routing table 800 to generate wireless communication node specific routing tables, such as the node routing table 512A.

Portion 802 of the routing table 800 indicates routing information specific to a wireless communication node within the mesh network, potentially corresponding to the EVSE unit identified as EVSEA. This portion details communication links from EVSEA to multiple nodes, as well as metrics like signal strength, signal quality, and/or distance for each link.

Portion 804 of the routing table 800 indicates routing information specific to another wireless communication node within the mesh network. Portion 804 similarly enumerates communication link attributes for a specific wireless communication node within the network topology. A further subset, portion 806, enumerates communication link attributes for another specific wireless communication node within the network topology.

For each of the subsets (portions) 802, 804, and 806, the routing table can include, but is not limited to, a source column that specifies the origin node for each listed communication link; a destination column that indicates the endpoint node intended for the data packet transmission; a signal strength column that quantifies the received signal power level at the destination node; a signal quality column that details a qualitative measure of the link reflecting (e.g., based on) the signal's integrity and the link's error characteristics; a distance column that provides a metric representing either the physical or network-implied distance between the source and destination, informing routing decisions that may prioritize proximity or path efficiency; and a type column that delineates the classification of the communication link or the protocol in use, which can guide the routing decision based on the nature of the transmitted data.

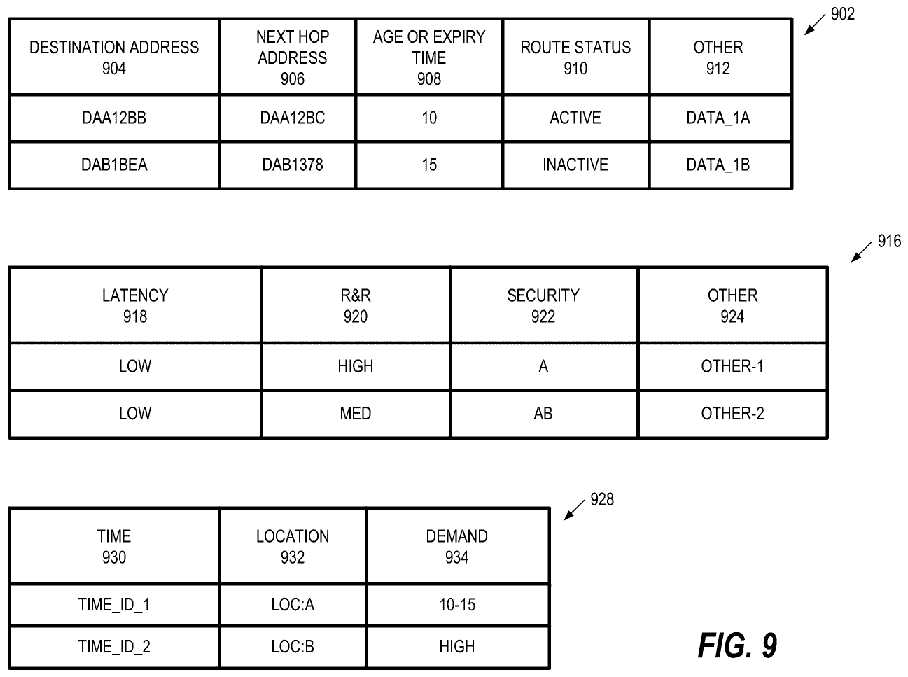

FIG. 9 provides a depiction of data structures 902, 916, and 928, each configured to store and organize data relevant to the operation of a mesh network. Although depicted as including two rows of data each, each of the data structures 902, 916, and 928 can include less than two or more than two rows of data. The data structure 902 represents a routing table that may reside at one or more of the wireless communication nodes of a mesh network. More specifically, data structure 902 may include a series of entries for routing communications from a wireless communication node to a destination address, such as another wireless communication node, energy asset 114, or edge environment 102. The entries are organized into columns, with each column responsible for holding specific routing information and each entry indicating information specific to a communication route, also referred to as a pathway and/or link. The data structure 902 can correspond to the routing table 708 and may be generated as node routing table 512A. In examples, the data structure 902 can include, but is not limited to, a destination address column 904, a next hop address column 906, an age or expiry time column 908, a route status column 910, and another column 912. In examples, the destination address column 904 holds network addresses for potential destination nodes. The destination addresses of potential destination nodes can be addresses of other wireless communication nodes, energy assets 114, mesh network coordinators such as mesh network coordinator 706, or other devices and components accessible at site 110 (of FIG. 1).

The next hop address column 906 can refer to the address of the wireless communication node to which a communication, such as a packet, should be forwarded next. For example, and with reference to FIG. 7, the next hop address of the node 704A could be node 704B and/or node 704E. In examples, the next hop address may depend on the destination address in the destination address column 904. Accordingly, a node 704E may include a next hop address for node 704H when the destination address in the destination address column 904 is the destination address for mesh network coordinator 706. In addition, the node 704E may include a next hop address for node 704A when the destination address in the destination address column 904 is for EVSE unit 702A. Accordingly, the next hop address column 906 records information related to the node to which a packet should be forwarded next.

The age or expiry time column 908 can refer to information specifying how long the routing information for a communication route should be kept before being updated. This information helps in maintaining an up-to-date routing table in a dynamic network environment. In some examples, the route optimizer 236 may provide the information in a routing table; however, if a wireless communication node is unable to update a communication route for one or more reasons (e.g., loss of communication with the route optimizer 236 and/or mesh network coordinator 706), the communication route may become inactive based on the information in the age or expiry time column 908.

The route status column 910 indicates the status of the communication route, such as but not limited to active, discovery underway, discovery failed, or inactive. This helps the wireless communication node understand whether the communication route is currently valid and usable. As previously discussed, if the communication route expires because the age or expiry time in the age or expiry time column 908 is exceeded, the communication route may be inactive. In such case, the route optimizer 236 can provide a new communication route and/or routing table, the wireless communication node can utilize a different communication route to reach a same destination address, and/or communication functionality of the wireless communication node can be limited to a set of basic communications (e.g., beacon communications) until a new communication route and/or new routing table can be updated.

The data structure 902 can also include other column 912 specifying other information or data associated with a communication route or link. In examples, the other column 912 can include, but is not limited to, a specific radio channel or a physical interface on the wireless communication node through which the packet, or communication, should be sent; a maximum number of hops indicating the maximum allowed number of intermediate wireless communication nodes (hops) that a packet, or communication, can pass through to reach its destination; a quality of service metric including information about the link quality, latency, or bandwidth of a specific communication route; a measure of link reliability; traffic load; communication route age or freshness; and communication route type such as but not limited to primary, backup, static, dynamic, etc.

In some examples, a data structure 916 may specify communication requirements and optimization criteria 508 for a mesh network supporting EVSE. The data structure 916 provides inputs to the mesh optimizer 510 to generate optimized node routing tables 512A based on the specific needs of the EVSE infrastructure. Considerations that can shape the routing configuration include, but are not limited to: prioritizing critical data flows related to real-time charging status updates, payment transactions, and vehicle authentication; ensuring dynamic adaptability and rapid reconfiguration as the EVSE expand or alter their topologies; incorporating redundant communication pathways and reliable routing mechanisms for mission-critical functions like billing and safety mechanisms; distributing network loads evenly during demand spikes at sites 110 to prevent bottlenecks; routing sensitive payment and personal data through the most secure node links and encrypted channels; and/or adapting routing decisions to handle environmental variability like physical obstructions, interference etc. for outdoor deployments.

By factoring in these EVSE-specific requirements, the data structure 916 may allow the mesh optimizer 510 to tune the node routing tables 512A to meet the connectivity, efficiency and resilience requests of mesh network supporting an electric vehicle charging infrastructure. An example data structure 916 can include latency information 918, reliability and redundancy information (illustrated as “R&R”) 920, security information 922, and other information 924. The latency information 918 can denote latency thresholds for time-critical data flows related to EVSE, where lower latency requirements could prioritize certain traffic. The reliability and redundancy information 920 could indicate reliability expectations (high/med/low) for important data, where higher reliability expectations could trigger redundant communication routes in routing tables. Security information 922 could indicate security levels like high, medium etc. that certain data flows or communication routes may expect, ensuring sensitive data gets routed through the most secure paths. The other information 924 could include additional routing criteria, such as, but not limited to, ranges for number of hops, energy budgets, interface/protocol types, bandwidth, etc.

The data structure 928 can include dynamic datasets indicative of changes within the mesh network environment over time. This temporal routing information allows optimization algorithms to adapt to evolving network conditions. The data structure 928 corresponds to the evolution data 516 previously depicted in FIG. 5 and described herein. In examples, the data structure 928 includes various categories of real-time routing criteria that characterize performance fluctuations within the mesh network. By processing this evolution data, route generator 518 can adjust wireless communication node routing tables accordingly, ensuring efficient data routing despite variability in network operations.

As illustrated in FIG. 9, the data structure 928 incorporates demand information 934, location information 932, time information 930, and other information. The demand information 934 may indicate shifts in the bandwidth and throughput requirements of wireless communication nodes or data types. Location information 932 indicates geographic or topological routing restrictions that may occur, for instance, if new EVSE is added. The time information 930 can include temporary or scheduled changes in routing availability, security, priority, and other aspects tied to certain hours of operation for example. The other information can encompass additional dynamic routing criteria, such as but not limited to, node mobility patterns, intermittent RF interference factors, and temporary power or connectivity losses at specific locations.

By tracking this multi-parameter routing information via the data structure 928, the mesh network can remain in an optimized configuration regardless of evolving device locations, sporadic network interruptions, variable power loads, and other operational fluctuations inherent to electric vehicle charging infrastructure. The data structure 928 provides route generator 518 with visibility needed to keep node routing tables 512A tuned to current network conditions.

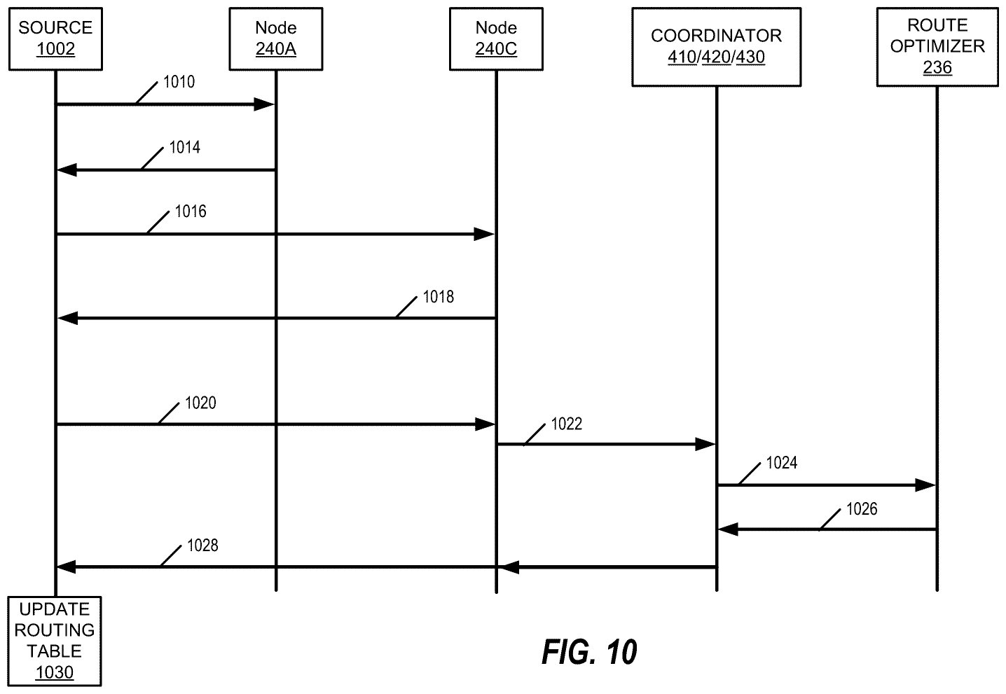

FIG. 10 depicts an interactive routing optimization process within a wireless mesh network, such as mesh network 238, comprising EVSE unit (illustrated as “source”) 1002, multiple wireless communication nodes 240C and 240A, a PAN coordinator 410/420/430, and a central route optimizer 236.

The EVSE unit 1002 represents an entry access point into the mesh network for an electric vehicle charging station, such as charging station 112. The EVSE unit 1002 is configured to transmit beacon signals 1010 and 1016 to elicit responses from nearby wireless communication nodes such as nodes 240A and 240C, respectively. The beacon signals 1010 and 1016 allow the EVSE unit 1002 to gather pertinent network information including, for example, statistics like link bandwidth, reliability, hop count from the mesh environment to optimize its data routing paths. The nodes 240A and 240C, serve as intermediate relay nodes within the mesh network architecture. Upon receiving an incoming beacon signal from EVSE unit 1002, the nodes 240A and 240C provide a response (1014 and 1018, respectively) with network information or data of their own based on analysis of local environment. The response may include signal quality, distance, and other information between EVSE unit 1002 and node 240A and between EVSE unit 1002 and node 240C.

A PAN coordinator 410/420/430 accumulates network status details from nodes across the mesh network through periodic transfer of information as represented by arrow 1020 and 1022, where node 240A can serve as a relay node. PAN coordinator 410/420/430 oversees topology management and routing table configuration. By aggregating extensive connectivity data, the PAN coordinator 410/420/430 forms a global view of the mesh network. This information can be relayed via communication pathway 1024 to a route optimizer 236.

The route optimizer 236 applies intelligent algorithms to determine optimal routing pathways for data packets between nodes of the wireless mesh network. The generated communication routes can be returned by the route optimizer 236 (e.g., 1026) to the awaiting PAN coordinator 410/420/430 as an updated routing table directive. Communication 1028 can be propagated via the mesh network to the EVSE unit 1002. The EVSE unit 1002 can then perform an update routing table directive 1030 to update the local routing table. Accordingly, the wireless mesh network continually refines node-specific routing policies for efficient, resilient data transfer aligned to the demands of electric vehicle supply equipment operations.

### Process for Creating and/or Managing a Routing Table of a Wireless Communication Code

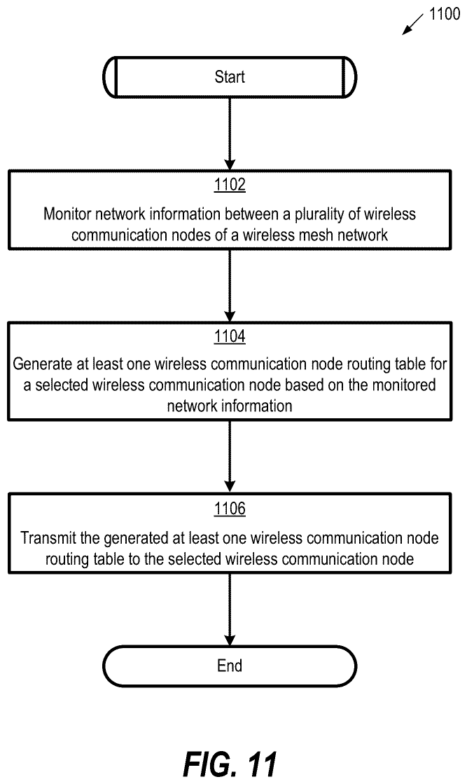

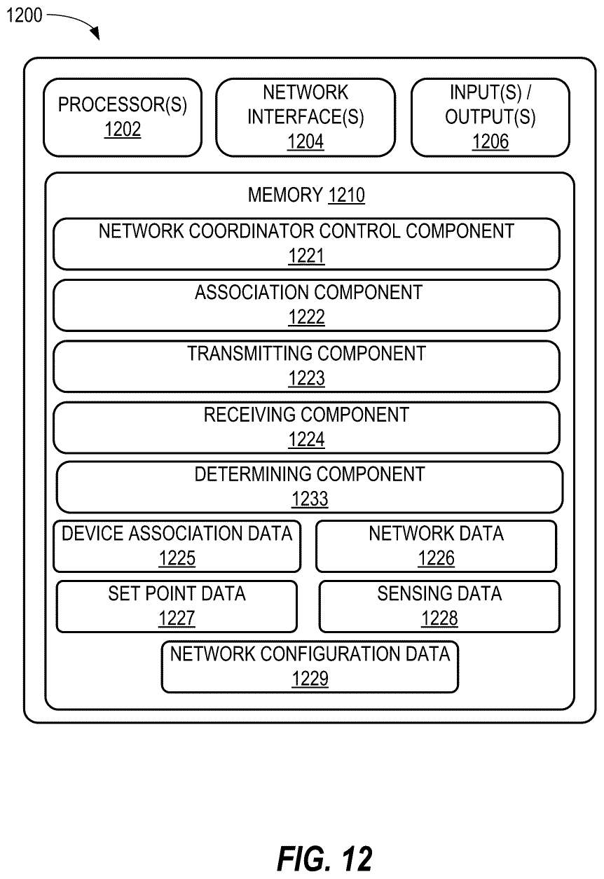

FIG. 11 depicts an example method 1100 for creating and/or managing a routing table of a wireless communication node, according to aspects provided herein. In some aspects, method 1100 can be implemented by the route optimizer 236 as depicted in FIG. 2 and FIGS. 5A-5B, and/or processing system 1200 of FIG. 12.

Method 1100 starts at block 1102 with monitoring network information between a plurality of wireless communication nodes of a wireless mesh network.

The method 1100 then continues to block 1104 with generating at least one wireless communication node routing table for a selected wireless communication node based on the monitored network information. In certain aspects, generating the at least one wireless communication node routing table for the selected wireless communication node includes determining link metrics between the selected wireless communication node and each of a plurality of wireless communication destination nodes based on the monitored network information; executing an optimization algorithm to generate a communication route from the selected wireless communication node to one or more wireless communication destination nodes based on the determined link metrics and communication route generation criteria defining objectives for communication route generation, the communication route generation criteria including one or more of latency, redundancy, load balancing, energy efficiency, or security; and populating the at least one wireless communication node routing table with the generated communication route.

The method 1100 then continues to block 1106 with transmitting the generated at least one wireless communication node routing table to the selected wireless communication node.

In some aspects of method 1100, the link metrics include at least one of: a signal strength, a link quality, an error rate, a number of hops, a physical distance, or a measure of reliability.

In some aspects of method 1100, the optimization algorithm includes at least one of: a network graph analysis algorithm, a linear optimization algorithm, a nonlinear optimization algorithm, a metaheuristic optimization algorithm, a machine learning-based optimization algorithm, or a swarm intelligence-based optimization algorithm.

In some aspects, method 1100 further includes monitoring updated network information for the wireless mesh network; and dynamically adjusting the generated communication route based on detecting changes between the monitored network information and the updated network information.

In some aspects of method 1100, executing the optimization algorithm includes executing an objective function configured to minimize a cost value based on the link metrics and the communication route generation criteria to generate the communication route.

In some aspects of method 1100, the objective function includes a first cost term associated with balancing communication traffic across available communication routes.

In some aspects, method 1100 further includes discovering a new wireless communication node added to the wireless mesh network; determining link metrics between the new wireless communication node and the selected wireless communication node based on the monitored network information; and updating the at least one wireless communication node routing table to include one or more communication routes between the new wireless communication node and the selected wireless communication node.

In some aspects, method 1100 further includes modeling a network topology graph based on discovered wireless communication nodes and communication links between the discovered wireless communication nodes; executing the optimization algorithm based on the modeled network topology graph to concurrently generate one or more communication routes from each of the plurality of wireless communication nodes to one or more wireless communication destination nodes; and generating a wireless communication node routing table for each of the plurality of wireless communication nodes, wherein each wireless communication node routing table is populated with corresponding one or more communication routes from a respective wireless communication node to one or more wireless communication destination nodes.

In some aspects of method 1100, the at least one wireless communication node routing table includes at least one communication route between the selected wireless communication node and at least one wireless communication destination node of the one or more wireless communication destination nodes.

In some aspects, method 1100 further includes monitoring evolution data indicating changes within the wireless mesh network over time, the evolution data including one or more of: wireless communication node additions, wireless communication node failures, link quality changes, traffic pattern shifts, or new physical obstacles; determining whether the evolution data indicates that existing communication routes between one or more wireless communication nodes should be updated based on current network conditions; and re-executing the optimization algorithm based on the evolution data to update the at least one wireless communication node routing table with communication routes matched to the current network conditions.

In some aspects of method 1100, the at least one wireless communication node routing table includes a primary communication route and a secondary communication route from the selected wireless communication node to the one or more wireless communication destination nodes.

Note that FIG. 11 is just one example of a method, and other methods including fewer, additional, or alternative steps are possible consistent with this disclosure.

### Example Processing System for Optimizing Communication Routes between Wireless Communication Nodes

FIG. 12 depicts an example processing system 1200 configured to optimize communication routes between wireless communication nodes in a mesh network, according to aspects provided herein.

Processing system 1200 includes one or more processors 1202. Generally, a processor 1202 is configured to execute computer-executable instructions (e.g., software code) to perform various functions, as described herein.

Processing system 1200 further includes one or more network interfaces 1204, which generally provide data access to any sort of data network, including personal area networks (PANs), local area networks (LANs), wide area networks (WANs), the internet, and the like.

Processing system 1200 further includes input(s) and output(s) 1206, which generally provide means for providing data to and from processing system 1200, such as via connection to computing device peripherals, including user interface peripherals.

Processing system 1200 further includes a memory 1210 comprising various components. In this example, memory 1210 includes a network coordinator control component 1221, an association component 1222, a transmitting component 1223, a receiving component 1224, a determining component 1233, device association data 1225, network data 1226, set point data 1227, sensing data 1228, and network configuration data 1229.

Processing system 1200 may be implemented in various ways. For example, processing system 1200 may be implemented as a computing device 402 within core device 302, described above with respect to FIGS. 3 and 4. Note that in various implementations, aspects may be omitted, added, or substituted from processing system 1200.

### Example Clauses

Implementation examples are described in the following numbered clauses:

Clause 1: A method for optimizing communication routes in a wireless mesh network comprising a plurality of wireless communication nodes associated with electric vehicle supply equipment (EVSE), the method comprising: monitoring network information between the plurality of wireless communication nodes of the wireless mesh network; generating at least one wireless communication node routing table for a selected wireless communication node based on the monitored network information, wherein generating the at least one wireless communication node routing table for the selected wireless communication node comprises: determining link metrics between the selected wireless communication node and each of a plurality of wireless communication destination nodes based on the monitored network information; executing an optimization algorithm to generate a communication route from the selected wireless communication node to one or more wireless communication destination nodes based on the determined link metrics and communication route generation criteria defining objectives for communication route generation, the communication route generation criteria comprising one or more of: latency, redundancy, load balancing, energy efficiency, or security; and populating the at least one wireless communication node routing table with the generated communication route; and transmitting the generated at least one wireless communication node routing table to the selected wireless communication node.

Clause 2: The method in accordance with Clause 1, wherein the link metrics comprise at least one of: a signal strength, a link quality, an error rate, a number of hops, a physical distance, or a measure of reliability.

Clause 3: The method in accordance with any one of Clauses 1-2, wherein the optimization algorithm comprises at least one of: a network graph analysis algorithm, a linear optimization algorithm, a nonlinear optimization algorithm, a metaheuristic optimization algorithm, a machine learning-based optimization algorithm, or a swarm intelligence-based optimization algorithm.

Clause 4: The method in accordance with any one of Clauses 1-3, further comprising: monitoring updated network information for the wireless mesh network; and dynamically adjusting the generated communication route based on detecting changes between the monitored network information and the updated network information.

Clause 5: The method in accordance with any one of Clauses 1-4, wherein executing the optimization algorithm comprises executing an objective function configured to minimize a cost value based on the link metrics and the communication route generation criteria to generate the communication route.

Clause 6: The method in accordance with Clause 5, wherein the objective function comprises a first cost term associated with balancing communication traffic across available communication routes.

Clause 7: The method in accordance with any one of Clauses 1-6, further comprising: discovering a new wireless communication node added to the wireless mesh network; determining link metrics between the new wireless communication node and the selected wireless communication node based on the monitored network information; and updating the at least one wireless communication node routing table to include one or more communication routes between the new wireless communication node and the selected wireless communication node.

Clause 8: The method in accordance with any one of Clauses 1-7, further comprising: modeling a network topology graph based on discovered wireless communication nodes and communication links between the discovered wireless communication nodes; executing the optimization algorithm based on the modeled network topology graph to concurrently generate one or more communication route from each of the plurality of wireless communication nodes to one or more wireless communication destination nodes; and generating a wireless communication node routing table for each of the plurality of wireless communication nodes, wherein each wireless communication node routing table is populated with corresponding one or more communication routes from a respective wireless communication node to one or more wireless communication destination nodes.

Clause 9: The method in accordance with any one of Clauses 1-8, wherein the at least one wireless communication node routing table comprises at least one communication route between the selected wireless communication node and at least one wireless communication destination node of the one or more wireless communication destination nodes.

Clause 10: The method in accordance with any one of Clauses 1-9, further comprising monitoring evolution data indicating changes within the wireless mesh network over time, the evolution data comprising one or more of: wireless communication node additions, wireless communication node failures, link quality changes, traffic pattern shifts, or new physical obstacles; determining whether the evolution data indicates that existing communication routes between one or more wireless communication nodes should be updated based on current network conditions; and re-executing the optimization algorithm based on the evolution data to update the at least one wireless communication node routing tables with communication routes matched to the current network conditions.

Clause 11: The method in accordance with any one of Clauses 1-10, wherein the at least one wireless communication node routing table comprises a primary communication route and a secondary communication route from the selected wireless communication node to the one or more wireless communication destination nodes.

Clause 12: A processing system, comprising: a memory comprising computer-executable instructions; and a processor configured to execute the computer-executable instructions and cause the processing system to perform a method in accordance with any one of Clauses 1-11.

Clause 13: A processing system, comprising means for performing a method in accordance with any one of Clauses 1-11.

Clause 14: A non-transitory computer-readable medium storing program code for causing a processing system to perform the steps of any one of Clauses 1-11.

Clause 15: A computer program product embodied on a computer-readable storage medium comprising code for performing a method in accordance with any one of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for optimizing communication routes in a wireless mesh network comprising a plurality of wireless communication nodes associated with electric vehicle supply equipment (EVSE), the method comprising:
monitoring network information between the plurality of wireless communication nodes of the wireless mesh network;
generating at least one wireless communication node routing table for a selected wireless communication node based on the monitored network information, wherein generating the at least one wireless communication node routing table for the selected wireless communication node comprises:
determining link metrics between the selected wireless communication node and each of a plurality of wireless communication destination nodes based on the monitored network information;
executing an optimization algorithm to generate a communication route from the selected wireless communication node to one or more wireless communication destination nodes based on the determined link metrics and communication route generation criteria defining objectives for communication route generation, the communication route generation criteria comprising one or more of:
latency,
redundancy,
load balancing,
energy efficiency, or
security; and
populating the at least one wireless communication node routing table with the generated communication route; and
transmitting the generated at least one wireless communication node routing table to the selected wireless communication node.

2. The method of claim 1, wherein the link metrics comprise at least one of:
a signal strength,
a link quality,
an error rate,
a number of hops,
a physical distance, or
a measure of reliability.

3. The method of claim 1, wherein the optimization algorithm comprises at least one of:
a network graph analysis algorithm,
a linear optimization algorithm,
a nonlinear optimization algorithm,
a metaheuristic optimization algorithm,
a machine learning-based optimization algorithm, or
a swarm intelligence-based optimization algorithm.

4. The method of claim 1, further comprising:
monitoring updated network information for the wireless mesh network; and
dynamically adjusting the generated communication route based on detecting changes between the monitored network information and the updated network information.

5. The method of claim 1, wherein executing the optimization algorithm comprises executing an objective function configured to minimize a cost value based on the link metrics and the communication route generation criteria to generate the communication route.

6. The method of claim 5, wherein the objective function comprises a first cost term associated with balancing communication traffic across available communication routes.

7. The method of claim 1, further comprising:
discovering a new wireless communication node added to the wireless mesh network;
determining link metrics between the new wireless communication node and the selected wireless communication node based on the monitored network information; and
updating the at least one wireless communication node routing table to include one or more communication routes between the new wireless communication node and the selected wireless communication node.

8. The method of claim 1, further comprising:
modeling a network topology graph based on discovered wireless communication nodes and communication links between the discovered wireless communication nodes;
executing the optimization algorithm based on the modeled network topology graph to concurrently generate one or more communication routes from each of the plurality of wireless communication nodes to one or more wireless communication destination nodes; and
generating a wireless communication node routing table for each of the plurality of wireless communication nodes, wherein each wireless communication node routing table is populated with corresponding one or more communication routes from a respective wireless communication node to one or more wireless communication destination nodes.

9. The method of claim 1, wherein the at least one wireless communication node routing table comprises at least one communication route between the selected wireless communication node and at least one wireless communication destination node of the one or more wireless communication destination nodes.

10. The method of claim 1, further comprising:
monitoring evolution data indicating changes within the wireless mesh network over time, the evolution data comprising one or more of:
wireless communication node additions,
wireless communication node failures,
link quality changes,
traffic pattern shifts, or
new physical obstacles;
determining whether the evolution data indicates that existing communication routes between one or more wireless communication nodes should be updated based on current network conditions; and
re-executing the optimization algorithm based on the evolution data to update the at least one wireless communication node routing table with communication routes matched to the current network conditions.

11. The method of claim 1, wherein the at least one wireless communication node routing table comprises a primary communication route and a secondary communication route from the selected wireless communication node to the one or more wireless communication destination nodes.

12. An apparatus for optimizing communication routes in a wireless mesh network comprising a plurality of wireless communication nodes associated with electric vehicle supply equipment (EVSE), the apparatus comprising:
one or more memories configured to store the communication routes associated with the wireless mesh network; and
one or more processors coupled to the one or more memories, the one or more processors configured to:
monitor network information between the plurality of wireless communication nodes of the wireless mesh network;
generate at least one wireless communication node routing table for a selected wireless communication node based on the monitored network information, wherein to generate the at least one wireless communication node routing table for the selected wireless communication node comprises to:
determine link metrics between the selected wireless communication node and each of a plurality of wireless communication destination nodes based on the monitored network information;
execute an optimization algorithm to generate a communication route from the selected wireless communication node to one or more wireless communication destination nodes based on the determined link metrics and communication route generation criteria defining objectives for communication route generation, the communication route generation criteria comprising one or more of:
latency,
redundancy,
load balancing,
energy efficiency, or
security; and
populate the at least one wireless communication node routing table with the generated communication route; and
transmit the generated at least one wireless communication node routing table to the selected wireless communication node.

13. The apparatus of claim 12, wherein the link metrics comprise at least one of:
a signal strength,
a link quality,
an error rate,
a number of hops,
a physical distance, or
a measure of reliability.

14. The apparatus of claim 12, wherein the one or more processors are further configured to:
monitor updated network information for the wireless mesh network; and
dynamically adjust the generated communication route based on detecting changes between the monitored network information and the updated network information.

15. The apparatus of claim 12, wherein to execute the optimization algorithm comprises to execute an objective function configured to minimize a cost value based on the link metrics to generate the communication route.

16. The apparatus of claim 12, wherein the one or more processors are further configured to:
discover a new wireless communication node added to the wireless mesh network;
determine link metrics between the new wireless communication node and the selected wireless communication node based on the monitored network information; and
update the at least one wireless communication node routing table to include one or more communication routes between the new wireless communication node and the selected wireless communication node.

17. The apparatus of claim 12, wherein the at least one wireless communication node routing table comprises at least one communication route between the selected wireless communication node and at least one wireless communication destination node of the one or more wireless communication destination nodes.

18. A non-transitory computer-readable medium storing instructions that, when executed by one or more processors, cause the one or more processors to:
monitor network information between a plurality of wireless communication nodes of a wireless mesh network, wherein the plurality of wireless communication nodes are associated with electric vehicle supply equipment (EVSE);
generate at least one wireless communication node routing table for a selected wireless communication node based on the monitored network information, wherein to generate the at least one wireless communication node routing table for the selected wireless communication node comprises to:
determine link metrics between the selected wireless communication node and each of a plurality of wireless communication destination nodes based on the monitored network information;
execute an optimization algorithm to generate a communication route from the selected wireless communication node to one or more wireless communication destination nodes based on the determined link metrics and communication route generation criteria defining objectives for communication route generation, the communication route generation criteria comprising one or more of:
latency,
redundancy,
load balancing,
energy efficiency, or
security; and
populate the at least one wireless communication node routing table with the generated communication route; and
transmit the generated at least one wireless communication node routing table to the selected wireless communication node.

19. The non-transitory computer-readable medium of claim 18, wherein the link metrics comprise at least one of:
a signal strength,
a link quality,
an error rate,
a number of hops,
a physical distance, or
a measure of reliability.

20. The non-transitory computer-readable medium of claim 18, wherein the optimization algorithm comprises at least one of:
a network graph analysis algorithm,
a linear optimization algorithm,
a nonlinear optimization algorithm,
a metaheuristic optimization algorithm,
a machine learning-based optimization algorithm, or
a swarm intelligence-based optimization algorithm.
